(19) United States
(12) Patent Application Publication
(10) Pub. No.: US 2006/0161496 A1
(43) Pub. Date: Jul. 20, 2006

(54) Money market trading system

(76) Inventors: James Robert Foster, London (GB); Neill Penney, Surrey (GB)

Correspondence Address: LAW OFFICES OF GRADY L. WHITE, LLC, 7272 WISCONSIN AVE, SUITE 300, BETHESDA, MD, 20814, US

(21) Appl. No.: 11/316,318

(22) Filed: Dec. 23, 2005

Related U.S. Application Data
(60) Provisional application No. 60/638,116, filed on Dec. 23, 2004.

(51) Int. Cl. G06Q 40/00

(52) U.S. Cl. 705/37

(57) ABSTRACT

A computerized automated trading system that allows users to execute money market transactions wherein the principal trading amount for a proposed money market transaction may be distributed across a plurality of different providers. Customers can make multiple money market deposits (or loans) for different amounts, and can split the total desired principal size of the desired deposit (or loan) across the plurality of providers, all from a single interactive user interface screen. Thus, the invention puts customers in a better position to obtain the best overall rate for the principal amount. The invention may also be configured to display a list of a customer's open money market trades, and allows the customer to select and roll over maturing trades. Customers can roll over single or multiple open trades for a given currency and use a different set of providers than was used for the original trades, or use a different distribution of the funds among the original set of providers. The invention provides these benefits for all types of money market transactions, including but not limited to, cash loans and deposits, certificates of deposit, treasury bills, repurchase agreements, and commercial paper transactions.

### CROSS-REFERENCE TO RELATED APPLICATIONS

This application is related to and claims priority under 35 U.S.C. § 119 to provisional application No. 60/638,116, filed on Dec. 23, 2004, which is incorporated into this application in its entirety by this reference.

### FIELD OF ART

The present invention relates generally to automated money market instrument trading systems and more particularly to automated money market instrument trading systems that allow users to execute orders in which the principal trading amount for a proposed money market transaction may be distributed across a plurality of different providers.

### RELATED ART

In the money market instrument trading business, customers execute trades through money market dealers (typically, banks or banking institutions), who are referred to as “liquidity providers,” or, more simply, as “providers.” In a typical scenario, a customer wishing to make a cash loan or deposit proposes a transaction by sending a request for price quotes (referred to as an “RFQ”) to one or more of the providers. The providers respond by returning price quotes for the proposed transaction, which indicate the prices the providers are willing to lend (or borrow) cash, as well as the size of the order the provider is willing to lend or borrow at the quoted prices. If a customer likes a price quote and wishes to enter into a deal with the sending provider, then the customer transmits to the provider an offer to trade assets for the price stated in the price quote (the offer is typically referred to as an “offer to deal”). If the price quote is still available (i.e., not expired) when the provider receives the customer's offer to deal, and the provider can meet the other terms in the RFQ and offer to deal, such as the quantity ordered and the proposed settlement date, then the provider typically accepts the offer to deal, and the proposed transaction is booked and executed. In a slightly different scenario, providers may stream price quotes to customers on a substantially continuous basis without receiving a specific RFQ for each price quote, and customers may initiate a transaction by sending an offer to deal against one or more price quotes within the stream.

Electronic money market trading systems have been introduced to facilitate faster, more efficient and, for auditing purposes, more traceable, money market trading transactions between customers and providers. Typically, these systems comprise a high-level trading application program (or, in some instances, a suite of high-level trading application programs) or a graphical user interface running on a customer's computer system (or network), which receives input from the user and sends electronic trading instructions to one or more high-level trading application programs running on the providers' computer systems (or networks). The customer's computer system and the providers' computer systems talk to each other by exchanging a series of messages via one or more data communication links established within an interconnected computer network, such as the Internet, a dedicated wide area network (WAN), or a corporate intranet. Typically, the high-level trading application programs and graphical user interfaces create messages and transmit them over the computer network by accessing a predefined collection or library of subroutines and function calls. The collection or library of subroutines and function calls is referred to as an application programming interface (“API”).

With the help of the APIs, the messages carrying requests for quotes, quotes, offers, confirmations and other trading instructions over the data communications links in the interconnected computer network may be channeled through an intermediate or centralized online trading server (or “portal”), which is also connected to the interconnected computer network. Typically, the intermediate online trading server is configured to coordinate, compare, match, error-check and/or log the messages on behalf of the customers and liquidity providers and communicate responses to the parties in real-time. In some cases, the online trading server is managed and operated by a third party. FX Alliance, LLC of New York, N.Y. (FXall) is one example of a third party operator of an online trading server for the money markets.

The conventional electronic money market trading systems fall into one of two categories: single-provider systems and multiple-provider systems. In the conventional single-provider systems, the customer will typically supply a principal size for a proposed money market transaction, which will be used by the system to produce a request for quotes for the principal size, which is in turn submitted to single money market provider. If the provider sends back a quote responsive to the request, the size of the quote will be equal to the principal size, and the customer will have the option of making an offer to deal on the quote or not. If the customer sends an offer to deal to the provider before the quote expires, and the provider responds by sending back a confirmation on the offer to deal, then the system is usually configured to execute a money market trade between the customer and the provider, wherein the size of the executed trade will be equal to the principal size.

The problem with single-provider money market trading systems is that the customer receives quotes from only one provider, and therefore, has no ability to compare the rates available from one provider to the rates available from other providers in the market before deciding whether to send an offer to deal. Thus, the customer has no way of shopping the proposed money market transaction around to multiple providers (or having the providers compete against each other) in order to obtain and select a more competitive rate.

Some have attempted to address this problem by introducing multi-provider money market trading systems, which allow the customer to send the request for quotes for a proposed money market transaction to a plurality of providers. For instance, if the principal size for the transaction is $250 million, the conventional multi-provider money market trading systems will generate and send a plurality of RFQs to a plurality of providers, where each RFQ requests quotes having offered sizes equal to the principal size (i.e., $250 million). Each provider can then submit a price quote for the principal size and the customer can compare these quotes and select for execution the price quote with the best terms.

But there are significant disadvantages associated with using conventional multi-provider money market trading systems. First, although they are designed to obtain a plurality of quotes from a plurality of providers, customers must still select one, and only one, of the plurality of quotes (i.e., only one of the providers) to execute the proposed transaction, while the rest of the quotes will be rejected or simply expire. Second, customers have no ability to send offers to deal, and providers have no ability to send quotes, for any transaction size that is not equal to the principal amount. If the principal size is $250 million, then the size of each quote shown to the customer is $250 million. Consequently, customers do not receive and do not have an opportunity to consider and select quotes from providers who cannot execute a deal for any size less than the full principal amount for the proposed transaction. Since the customer does not receive and cannot select smaller quotes having smaller sizes, the customer cannot divide the loan or deposit among multiple providers in order to achieve a better overall rate.

These limitations can, and usually do, lead to a significant number of lost opportunities for both customers and providers. It is often the case, for example, that a smaller provider, who does not have access to as much cash as a larger provider, can and would offer the best rate for a smaller, yet significant portion of a proposed transaction if that provider only had the opportunity to submit a quote for a transaction having a size smaller than the full principal size. In some cases, customers would prefer to execute several smaller sized deals (relative to the principal amount) with several providers if the overall rate achieved by executing the several smaller deals is better than the rate obtained from a single provider for the full principal amount. Conventional money market trading systems do not provide this functionality. Accordingly, there is considerable need in the money market trading business for an electronic money market trading system that gives customers wanting to execute an order for a principal amount the ability to fill that order by executing a plurality of smaller deals with a plurality of providers.

### SUMMARY OF THE INVENTION

The present invention addresses the above-described needs, as well as other disadvantages associated with conventional money market trading systems, by providing a computerized online trading system and user interface which automatically produces a plurality of requests for quotes for a plurality of providers, and which allows the customer to receive and select for execution a plurality of quotes that may comprise sizes that are less than the principal size. With the invention, customers can make multiple money market deposits (or loans) for different amounts, and can split the total desired principal size of the desired deposit (or loan) across the plurality of providers, all from a single interactive user interface screen. Thus, the invention puts customers in a better position to obtain the best overall rate for the principal amount. The invention provides these benefits for all types of money market transactions, including but not limited to, cash loans and deposits, certificates of deposit, treasury bills, repurchase agreements, and commercial paper transactions.

In preferred embodiments, the system has at least two modes of operation: a simple execution mode and an advanced execution mode. In the simple execution mode, one RFQ is sent to all of the provider banks. Thus, all of the banks are asked to provide quotes having offered sizes that are equal to the principal size. In the advanced execution mode, the system allows the user to change the requested size for any particular provider, and use differing requested sizes for each provider, and to selectively select quotes having different offered sizes, as needed, until the entire principal size is loaned or deposited. If desired, the customer may submit the requests for quotes to the multiplicity of providers consecutively (i.e., non-simultaneously) and execute on the responsive price quotes until the entire principal size is processed. Alternatively, the user can submit a group of requests for quotes to a group of providers substantially simultaneously, but with varying requested sizes. The advanced execution mode also provides input fields configured to allow the customer to terminate a pending request for quote and request a new rate for the proposed transaction, thereby initiating a negotiation with the providers, which the customer hopes will eventually lead to a better overall rate for the total principal amount. With this functionality, the customer can negotiate with a multitude of providers simultaneously, and can accomplish this while using a single user interface screen.

In general, the invention comprises a network interface, a display device, an input device and a user interface controller. The network interface provides a communication channel for communication with a plurality of providers. The input device (such as a keyboard, mouse, touchpad, touch screen or cursor, or some combination of keyboard, mouse, touchpad, touch screen or cursor), can be manipulated by a human operator to supply a principal size for a money market transaction. The input device can also be manipulated by the human operator to activate a start control displayed on the display device. The start control is a button, image or icon on the screen, which the customer can activate to start the quoting process with the plurality of providers.

The user interface controller is configured to produce a plurality of requests for quotes for the plurality of providers, each request for quote having a requested size for the provider to which the request is sent. Although the requested sizes in the requests for quotes may be initially populated with the principal size, this value can be changed by the customer so that at least one of the requested sizes in the plurality of requests for quotes, and maybe all of them, is less than the principal size. For example, if the principal size for the proposed money market transaction is $250 million, then the user interface controller may be configured to produce five requests for quotes for five different providers, each having a requested size of $50 million. In this case, all of the requested sizes for all of the requests for quotes are equal. Alternatively, and depending on the preferences of the customer, the user interface controller may be configured or manipulated by the operator to produce five requests for quotes having requested sizes that are all different from each other.

The user interface controller also causes the display device to display a first collection of fields representing the plurality of requests for quotes it has produced. The collection of fields are configured to receive from the user additional or modified trading details for the money market transaction, such as, for example, the principal size, a value date, a maturity date, a new requested size, etc. Then, in response to manipulation of the input device by the operator to activate the start control, the user interface controller submits the plurality of requests for quotes to the plurality of providers via the network interface substantially simultaneously.

Submitting a plurality of requests for quotes “substantially simultaneously” means the requests for quotes are sent to all of the designated providers by activating one control on the display screen, and without additional action on the part of user, so that the designated providers will have an opportunity to receive, review and respond to the requests roughly during the same time period. The plurality of requests do not have to be sent at exactly the same instant in order for this to occur. Moreover, it will be appreciated by those skilled in the art that it is rarely necessary for any modern computer system to execute instructions simultaneously in order to give the impression of simultaneous execution to a human operator. The important thing is that each provider receives the request for quote at roughly the same time (as determined by human perception and human reaction standards) and that each provider will have roughly an equal opportunity to submit a responsive quote before the customer must select a quote for execution. Accordingly, the invention may be implemented in systems that send out the requests for quotes in rapid succession, as well as those that send out the requests for quotes simultaneously.

In preferred embodiments, the first collection of fields includes a size field and a rate field representing the size and rate values in each request for quote. Before activating the start control on the display device, the customer can manipulate the input device to change the size and rate fields in any one of the requests for quotes (or all of them), which causes the user interface controller to modify the requested size and requested rate values in the request for quotes. Now, when the customer activates the start control, the modified requests for quotes will be sent to the plurality of providers.

When the providers submit price quotes responsive to the requests for quotes, the user interface controller displays a second collection of fields comprising selectable buttons representing the price quotes for the proposed money market transaction, including for example the offered sizes and interest rates for the quotes. In preferred embodiments, the selectable buttons that represent the price quotes having the best rates and the selectable buttons representing the quotes having offered sizes that are less than the requested principal size are visibly distinguished (e.g., flashing, blinking or specially colored) from selectable buttons representing other price quotes, thereby making it easier for the user to select the most appropriate quotes. The system allows the customer to select a provider by “clicking” on an offered size button, which causes the system to submit an offer to deal against the quote represented by the selected offered size button. If the provider accepts and/or confirms the offer to deal, the system automatically books an order for the proposed money market transaction.

Significantly, after selecting a first quote, the customer may also select a second quote (i.e., a second provider) from the second collection of fields, and the second quote will automatically book a second order for the proposed money market transaction. The customer may subsequently also select and book a third, fourth and fifth quote, and so on. In other words, the selection of the first quote does not automatically terminate any of the other quotes and does not prevent the customer from selecting additional quotes received from other providers in response to the plurality of requests. This functionality allows the customer to continue selecting and processing quotes, one after another, until the entire principal size is achieved. Preferred embodiments also display a “select all” button on the display screen, which the customer can activate with the input device in order to select all of the quotes at one time.

The present invention also provides a method for trading money market instruments on a computer system, comprising the steps of: (1) providing a network interface for communication with a plurality of providers; (2) providing a display device; (3) providing an input device which can be manipulated by a human operator to supply a principal size for a money market transaction and activate a start control displayed on the display device; and (4) providing a user interface controller that will (i) produce a plurality of requests for quotes for the plurality of providers, each having a requested size, wherein at least one requested size in the plurality of requests for quotes is less than the principal size, (ii) cause the display device to display a first collection of fields representing the plurality of requests for quotes, and (iii) in response to manipulation of the input device by the operator to activate the start control, send the plurality of requests for quotes to the plurality of providers via the network interface substantially simultaneously.

As will be described in detail below, the present invention also provides a computer system and a method for rolling over open trades. The computer system comprises a network interface for communication with a plurality of providers, a display device, an input device and a user interface controller. The input device can be manipulated by a human operator to activate a rollover control displayed on the display device, the rollover control being associated with an original set of open trades having a total principal size that is distributed among an original set of providers. In response to activation of the rollover control, the user interface controller that will obtain from the original set of providers, via the network interface, new quotes for a new set of trades corresponding to the original set of open trades, and cause the display device to display a first collection of fields representing the new quotes and a plurality of requests for quotes for the plurality of providers. If the operator manipulates the input device to modify the first collection of fields to redistribute the total principal size, then the user interface will modify the plurality of requests for quotes and send the modified plurality of requests for quotes to the plurality of providers via the network interface.

### BRIEF DESCRIPTION OF THE DRAWINGS

The present invention and various aspects, features and advantages thereof are explained in detail below with reference to exemplary and therefore non-limiting embodiments and with the aid of the drawings, which constitute a part of this specification and include depictions of the exemplary embodiments. In these drawings:

FIG. 1 contains a high-level block diagram illustrating the major functional components of a customer trading system configured to operate according to an embodiment of the invention.

FIGS. 2 and 3 contain high level block diagrams of exemplary computer networking environments where a customer trading system, such as the system depicted in FIG. 1, might be used.

FIG. 4 contains a high-level block diagram of a trading server that might be used with embodiments of the present invention.

FIG. 5 contains a Unified Modeling Language (UML) sequence diagram illustrating the sequence and timing of messages and data that are passed between the customer, the customer trading system, the trading server and the provider trading systems in a network configured to operate according to embodiments of the invention.

FIGS. 6, 7 and 8 contain high-level flow diagrams illustrating the steps that may be performed by a money market trading system configured to operate according to embodiments of the invention.

FIGS. 9, 10, 11 and 12 contain exemplary screenshots of user interface screens that could be used to execute money market instrument trades according to embodiments of the present invention.

FIGS. 13, 14 and 15 contain exemplary screenshots of user interface screens that could be used to make rollover trades according to embodiments of the present invention.

### DETAILED DESCRIPTION OF PREFERRED EMBODIMENTS

With reference to the figures, a detailed discussion of exemplary embodiments of the invention will now be presented. Notably, the invention may be implemented using software, hardware, firmware, or any combination thereof, as would be apparent to those of skill in the art upon reading this disclosure.

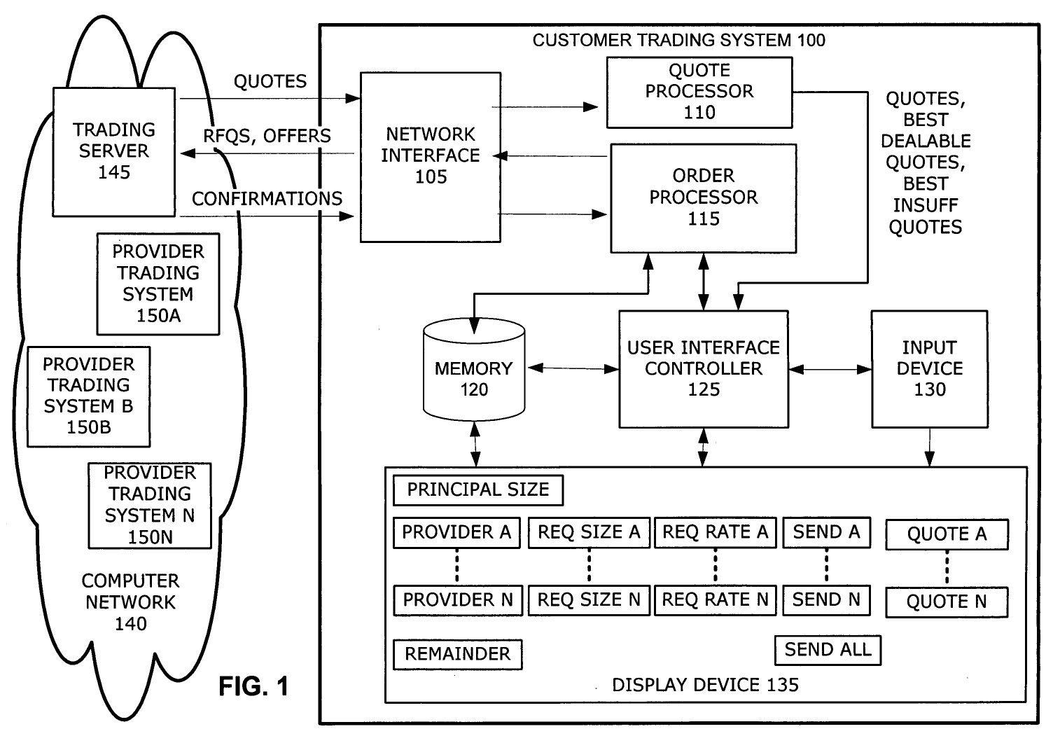

FIG. 1 contains a high-level block diagram illustrating the major functional components of a customer trading system configured to operate according to an embodiment of the invention. As shown in FIG. 1, preferred embodiments of the present invention include network interface 105, display device 135, input device 130, user interface controller 125, memory 120, quote processor 110 and order processor 110. The system is coupled, via the network interface 105 to a computer network 140 that includes a trading server 145 and a plurality of provider trading systems, represented in FIG. 1 as provider trading system 150A, provider trading system 150B and provider trading system 150N. Network interface 105 comprises network adapter cards, adapter card drivers, web server software and hardware, application programming interfaces, etc. typically used to connect an online server with remote clients in an interconnected computer network, such as the Internet.

Display device 135, input device, user interface controller 125 and memory 120 together make up the user interface for communication with a human operator in preferred embodiments of the invention. Display device 125 comprises a computer output surface and projecting mechanism that shows text and often graphic images to the customer, using, for example, a cathode ray tube (CRT), liquid crystal display (LCD), light-emitting diode, gas plasma, or other image projection technology. The display device usually includes a screen or projection surface and the hardware and software that produce the information on the screen. In some systems, the display device is packaged in a separate unit called a monitor. In other systems, the display is integrated into a unit with the processor and other parts of a computer. Displays (and monitors) are also sometimes called video display terminals (VDTs). Most computer displays use analog signals as input to the display image creation mechanism. This requirement and the need to continually refresh the display image mean that the computer usually requires a display or video adapter. The video adapter takes the digital data sent by application programs, stores it in video random access memory (video RAM), and converts it to analog data for the display scanning mechanism using a digital-to-analog converter (DAC).

Input device 130 comprises a keyboard, mouse, stylus, touchpad, button, touch screen, microphone, computer program, or any other type of hardware or software device that a human operator may manipulate to transfer data to a computer or computer program. Most often the input device will be implemented via a keyboard and mouse. Memory 120 comprises an electronic storage area where a computer microprocessor can store and retrieve instructions and data, such as a hard disk, CDROM, magnetic tape, random access memory area, memory stick or card, etc.

Display device 135, input device 130 and memory 120 are operatively coupled to user interface controller 125, which is typically a computer program, executable on a microprocessor, configured to receive data via the input device 130, to store data on memory 120 and to display text, data and graphical images on display device 135. In preferred embodiments of the present invention, user interface controller 125 causes display device 135 to display a prompt for the customer to enter a principal size for a proposed money market transaction. In response to the prompt, the customer manipulates input device 130 to provide the requested principal size. User interface controller 125 receives the principal size and, based on the principal size, produces a plurality of requests for quotes to be sent to a plurality of providers. User interface controller 125 stores the plurality of requests for quotes in memory 120.

Next, user interface controller 125 causes display device 135 to display a collection of fields representing the automatically-produced plurality of requests for quotes (the collection of fields representing the plurality of requests for quotes are labeled in FIG. 1 as “PROVIDER A” through “PROVIDER N9,” “REQ SIZE A” through “REQ SIZE N” and “REQ RATE A” through “REQ RATE N”). Preferably, these fields, which represent the provider banks, the requested sizes and the requested rates for each of the requests for quotes, are initially populated by user interface controller 125 according to a set of user preferences that have been previously stored in memory 120 or elsewhere, or which are provided by the operator along with the principal size. As will be described below, these fields also may be populated with provider and requested size information for existing open trades in order to facilitate rolling over those existing open trades.

User interface controller 125 also displays on display device 135 a start control switch (labeled in FIG. 1 as “SEND ALL”), which can be activated via input device 130 to start the quoting process by transmitting all of the requests for quotes to a plurality of providers via network interface 105 substantially simultaneously. In addition to the single start control, user interface controller 125 may be further configured to display on display device 135 a series of other buttons (labeled in FIG. 1 as “SEND A” through “SEND N,”) which may be activated via input device 130 to send an individual request for quote to an individual provider. If the customer manipulates input device 130 to modify any of the provider, requested size or requested rate fields displayed on display device 135 prior to activating the start control, then the modified value will be recorded as part of a modified request for quote, stored in memory 120, and displayed in the appropriate request for quote field on display device 135.

Activation of the start control (“SEND ALL”) displayed on display device 135 causes interface controller 125 to send the plurality of requests for quotes to provider trading system 150A, provider trading system 150B through provider trading system 105N via network interface 105 and trading server 145.

The provider trading systems respond to the requests for quotes by sending quotes responsive to the requests for quotes back to the customer trading system 100 via trading server 145. In preferred embodiments, customer trading system 100 also includes a quote processor 110, which analyzes the incoming quotes and identifies the best quotes (i.e., those quotes having the best rates). For example, if the quote is for a deposit instrument, then the best quote in the plurality of quotes is the quote having a rate that is numerically greater than or equal to (not less than) any other quote. If the quote is for a loan instrument, then the best quote in the plurality of quotes is the quote having a rate that is numerically less than or equal to (not greater than) any other quote. In preferred embodiments, there may be more than one best quote simultaneously.

Quote processor 110 also identifies quotes having offered sizes that are insufficient when compared to the requested size in the request for quote sent to that provider. For example, if the requested size is $50 million, but the provider offers $35 million, then the quote contains an offered size that is insufficient. The best quote and best insufficient quote information are then passed, along with the quotes themselves, back to user interface controller 125, which stores it in memory 120. Next, user interface controller 125 causes display device 135 to display a second collection of fields (labeled in FIG. 1 as “QUOTE A” through “QUOTE N”) representing the received and stored quotes. Preferably, although not necessarily, quotes having the best prices or which are of insufficient sizes will be visibly distinguished from other quotes by special coloring, special fonts or text, or other characteristics, so that the user can quickly identify and select or reject them.

If the customer manipulates input device 130 to select one of the quotes in the second collection of fields, user interface controller 125, in conjunction with optional order processor 115, will book the proposed money market transaction using the selected quote and the selected provider. User interface 125 and/or order processor 110 will also record the booking information in memory 120. The customer's selection of one of the quotes represented by the second collection of fields does not prevent the customer from selecting and executing deals on the remaining quotes. Accordingly, the customer may also manipulate input device 130 to select a second, third or fourth quote for processing. In preferred embodiments, user interface controller 125 also displays on display device 135 fields showing the principal size, as well as the amount remaining to be loaned or deposited for the proposed money market transaction.

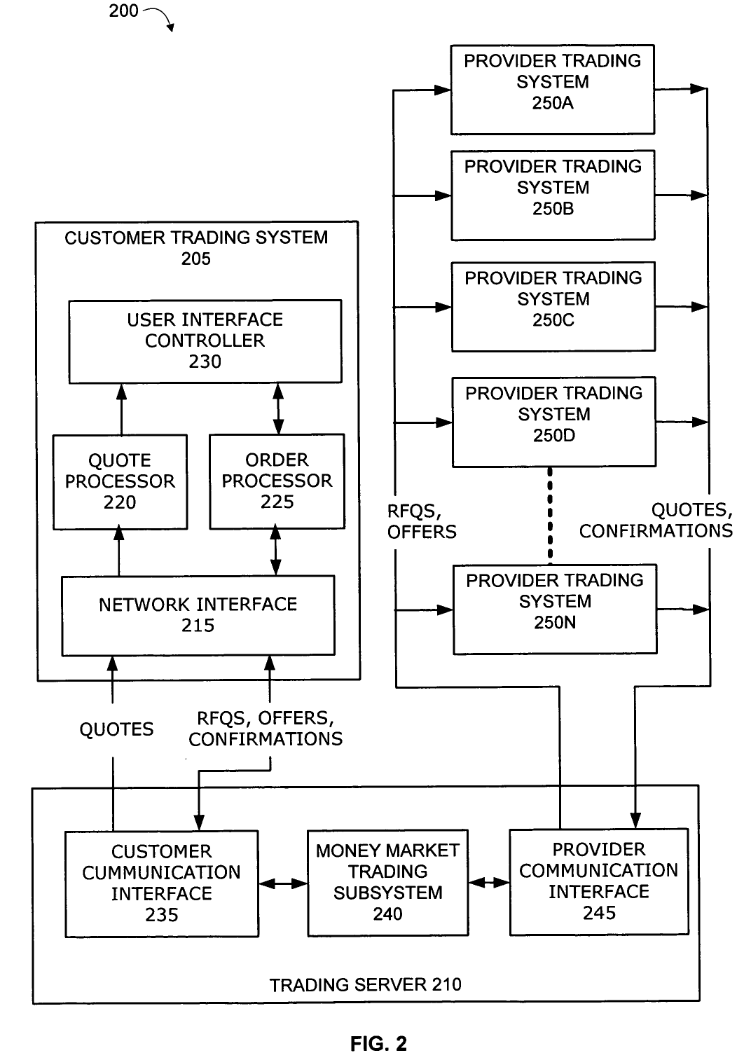

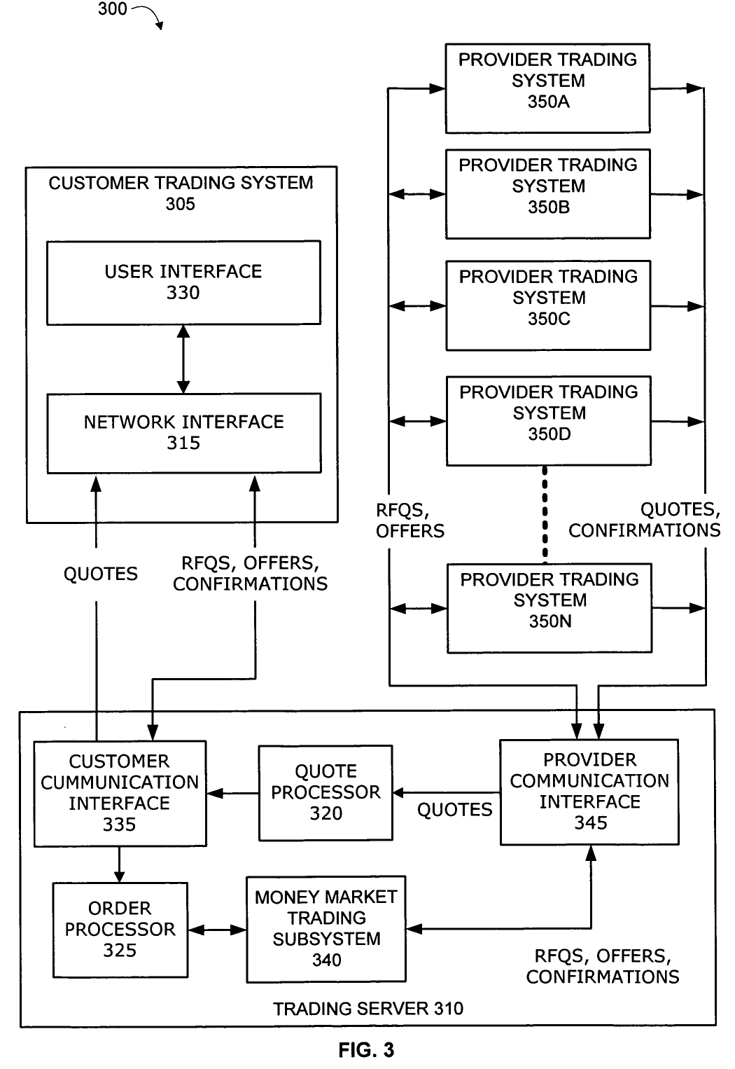

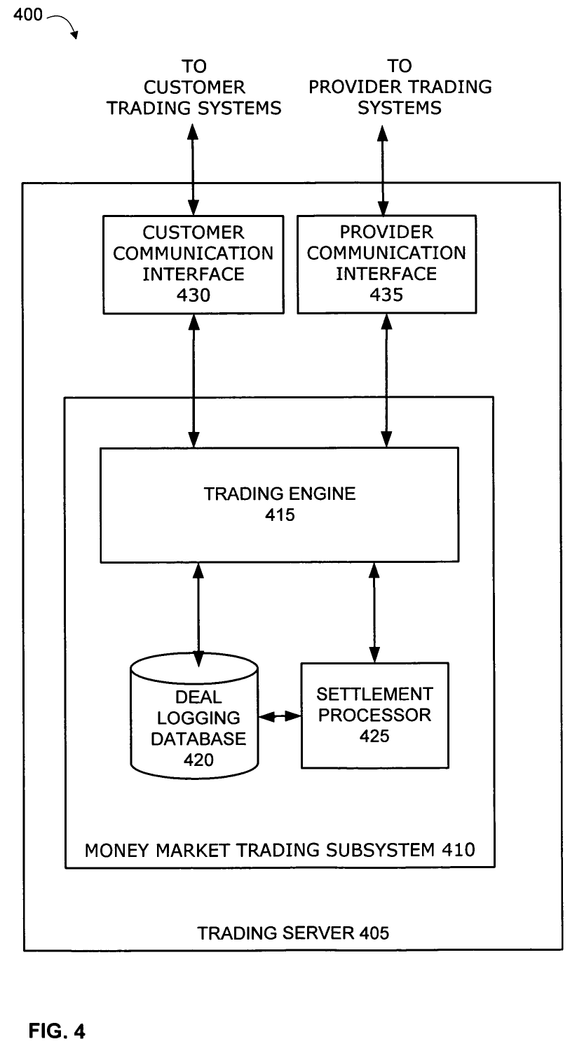

FIGS. 2 and 3 contain high level block diagrams of exemplary computer networking environments where a customer trading system, such as the system depicted in FIG. 1, might be used. As shown in FIG. 2, customer trading system 205 comprises user interface controller 230, quote processor 220, order processor 225 and network interface 215, which were previously described above with reference to user interface controller 125, quote processor 110, order processor 115 and network interface 105, respectively, in FIG. 1. Trading server 210, which is coupled to customer trading system 205 via an interconnected computer network (not shown in FIG. 2), such as the Internet, comprises a money market trading subsystem 240 (described below with reference to FIG. 4), customer communication interface 235 and provider communication interface 245. Customer communication interface 235 provides network connectivity, through the computer network, to one or more customer trading systems, such as customer trading system 205. Provider communication interface 245 provides network connectivity to a plurality of provider trading systems (shown in FIG. 2 as provider trading systems 250A-250N).

FIG. 3 illustrates an embodiment of the present invention that is slightly different from the embodiment illustrated in FIG. 2. In the embodiment of FIG. 3, the quote processor 320 and order processor 325, whose functions were described above with reference to quote processor 110 and order processor 115 in FIG. 1, reside on the trading server 310 instead of customer trading system 305. Similar to the components of the embodiment illustrated in FIG. 2, the embodiment in FIG. 3 comprises trading server 310, which is coupled to customer trading system 305 via an interconnected computer network (not shown in FIG. 3), such as the Internet. In addition to quote processor 320 and order processor 325, trading server 305 comprises a money market trading subsystem 340 (described below with reference to FIG. 4), customer communication interface 335 and provider communication interface 345. Customer communication interface 335 provides network connectivity, through the computer network, to one or more customer trading systems, such as customer trading system 305. Provider communication interface 345 provides network connectivity to a plurality of provider trading systems (shown in FIG. 3 as provider trading systems 350A-350N).

FIG. 4 illustrates, in somewhat more detail, a trading server configured to operate in conjunction with customer trading systems configured to operate according to the invention. As shown in FIG. 4, trading server 405 comprises customer communication interface 430, provider communication interface 435 and money market trading subsystem 410. Money market trading subsystem 410 comprises a trading engine 415, which is typically a computer software program configured, according to methods well-known in the art, to receive and process messages containing money market trading instructions and to store the details concerning those processed trades in a deal logging database 420. At the appropriate time (e.g., on settlement day), settlement processor 425 retrieves the details of the executed trades from deal logging database 420 and matches those details with the details received from the customer trading and provider trading systems.

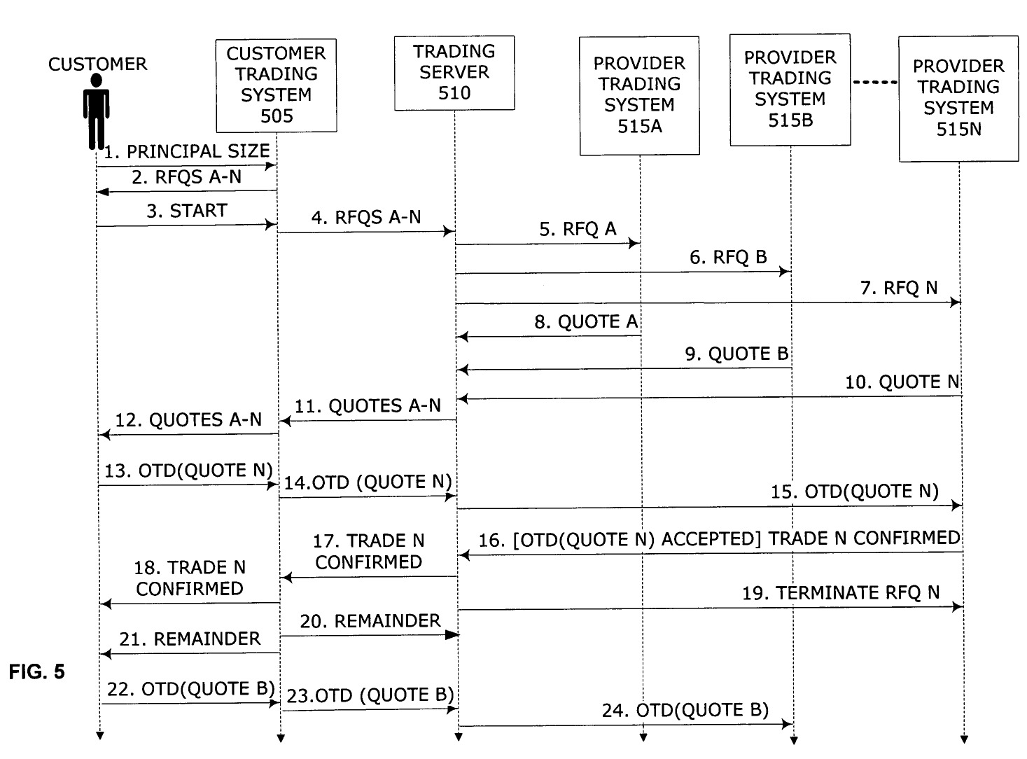

FIG. 5 contains a Unified Modeling Language (UML) sequence diagram illustrating the sequence and timing of messages and data that are passed between the customer, the customer trading system, the trading server and the provider trading systems in a network configured to operate according to embodiments of the invention. As shown in FIG. 5, the customer first supplies a principal amount (message 1) to the customer trading system 505, which produces a plurality of RFQs A-N to be sent to the provider trading systems 515A-515N. Customer trading system 505 displays RFQs A-N to the customer on the display device (message 2). The customer then uses the input device to modify the requests for quotes and to activate the start control on the display device of customer trading system 505 (message 3). This causes customer trading system 505 to send RFQs A-N to trading server 510 (message 4), which then sends RFQ A to provider trading system 515A (message 5), RFQ B to provider trading system 515B (message 6) and RFQ N to provider trading system 515N (message 7).

Provider trading systems 515A-515N respond to RFQs A-N by sending quotes A-N back to trading server 510 (messages 8, 9 and 10 in FIG. 5). Trading server 510 forwards the quotes A-N to customer trading system 505 (message 11), which in turn displays quotes A-N to the customer (message 12). If the customer uses the input device to send an offer to deal on quote N (message 13), customer trading system 505 will send the offer to deal to trading server 510 (message 14), which forwards the offer to deal back to provider trading system 515N (message 15). If provider trading system 515N accepts the offer to deal on quote N (message 16), trading server 510 will book the order and send a confirmation to customer trading system 505 (message 17), which will be displayed to the customer (message 18). After the trading server 510 books the order and sends the confirmation for the offer to deal on quote N to customer trading system 505 (message 17), it will also send a message back to provider trading system 515N to terminate the quote (message 19). Notably, trading server 510 does not terminate the quotes from provider trading systems 515A and 515B, which are still active and available for the customer to select.

After the receiving a confirmation that the order on quote N is booked, customer trading system 505 is optionally configured to send messages to the customer, as well as trading server 510, that, based on the principal amount entered in the first step, there is a remainder amount that the customer still needs to loan or deposit (messages 20 and 21). At this point, the customer can send a second offer to deal by selecting, for example, quote B (message 22), which will then be forwarded to trading server 510 (message 23) and provider trading system 515B (message 24) for further processing.

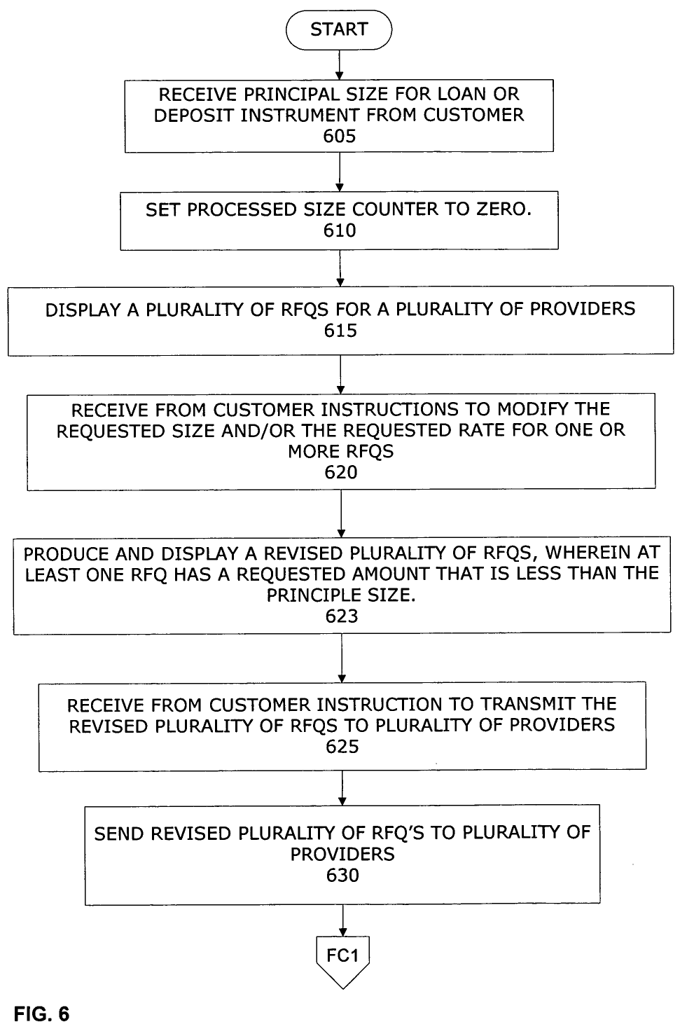

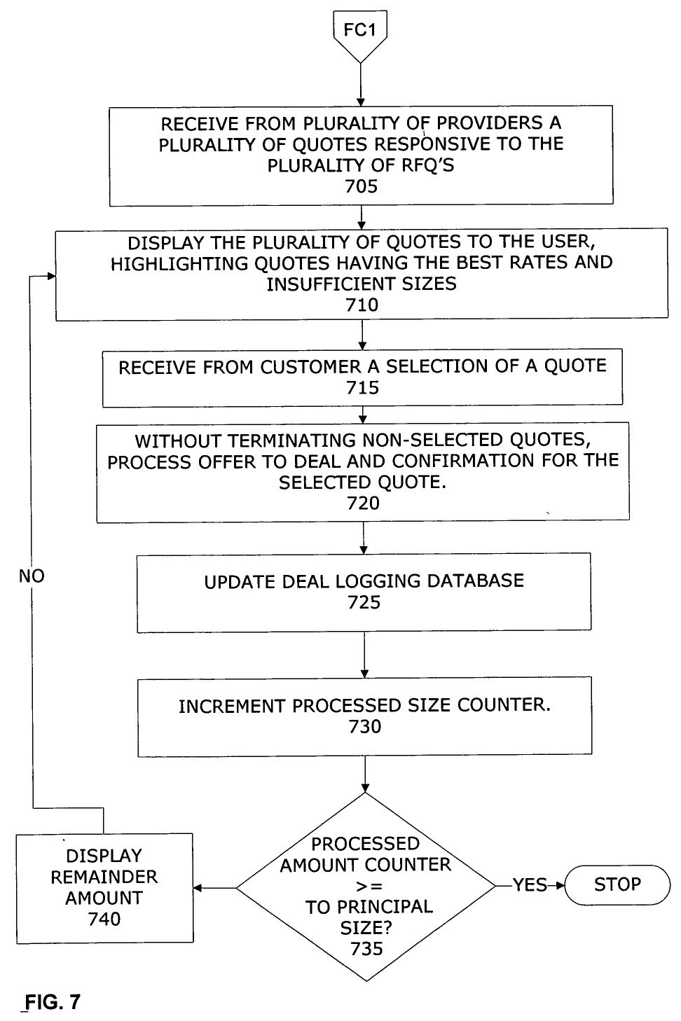

FIGS. 6 and 7 contain a high-level flow diagram illustrating the steps that may be performed by a money market trading system configured to operate according to embodiments of the invention. First, at step 605 in FIG. 6, the system receives a principal size for a loan or deposit. At step 610, the system sets a processed amount counter equal to zero. Based on the principal size and a set of customer preferences, the system next displays to the customer a plurality of requests for quotes for a plurality of providers (step 615). Next, the system receives instructions from the customer to modify the requested size, the requested rate, or both, for one or more of the requests for quotes (step 620). Here, the customer is allowed to change the requested sizes in the plurality of requests for quotes, so that at least one of the requests for quotes has a requested size that is less than the principal size. In the next step, step 623, the system produces and displays to the customer the revised set of requests for quotes, wherein at least one of the requests for quotes has a requested size that is less than the principal size. At step 625, the system receives an instruction from the customer to transmit the revised plurality of requests for quotes to the plurality of providers. In other words, the customer activates the start control to start the quoting process. In response, the system sends the plurality of quotes to the plurality of providers (step 630).

Next, processing continues at step 705 in FIG. 7 by way of flow chart connector FC1, where the system receives a plurality of quotes responsive to the plurality of requests for quotes. The plurality of quotes are displayed to the customer, highlighting quotes having the best rates and insufficient sizes (step 710). If the customer generates an offer to deal by selecting one of the quotes (step 715), the system is configured to process an order for the offer to deal for the selected quote without terminating the non-selected quotes (step 720). Next, the system will update the deal logging database (step 725) and increment the processed size counter by an amount equal to the offered size of the selected quote (step 730). Finally, at step 735, the system determines whether it has already processed the entire principal size. If the answer is yes, then processing ends. On the other hand, if the answer is no, then the system displays the remaining amount to be loaned or deposited (step 740) and processing returns to step 710.

Rolling Over Open Trades

A rollover trade for a money market instrument refers to the process of extending an existing money market instrument (such as a loan or deposit) for a further period of the same term. In preferred embodiments of the present invention, the user interface controller is also configured to display on the display device a list of a customer's open trades, and to allow the customer to select and roll over maturing trades. Significantly, the present invention allows customers to roll over multiple open trades for a given asset (a process known as “rolling a position”) using a different set of providers than the original trades, or using a different distribution of funds among the original set of providers, if desired, and to accomplish the position rollover using a single user interface screen. Customers may also roll over open trades using the same set of providers and the same distribution of funds. The present invention implements this functionality by producing and displaying to the customer a set of requests for quotes wherein the providers and the requested sizes for the requests for quotes correspond to the original providers and original requested sizes for the open trades. The customer may then modify the provider list, modify the requested sizes for each provider, request and select quotes for the rollover trades, and execute the trades with the selected set of providers.

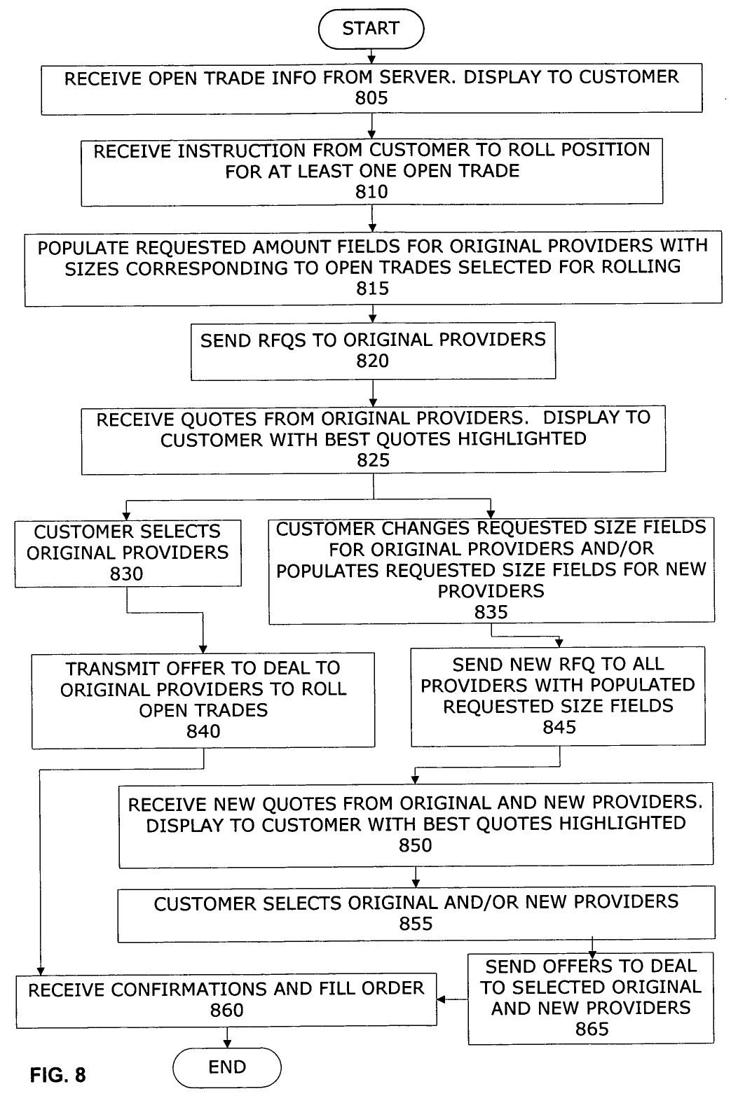

FIG. 8 contains a high-level flow diagram illustrating the steps performed by embodiments of the invention to roll a position. Beginning at step 805, the system first receives open trade information from a trading server and displays this information to the customer. In preferred embodiments, the open trade information is displayed in a separate window at the bottom of the display device along with a “roll position” control which the customer can activate by manipulating the input device. Activation of the roll position control generates an instruction from the customer to roll the position for at least one open trade (step 810). In response, the system produces a plurality of requests for quotes comprising fields corresponding to providers and requested sizes. The system automatically pre-populates the provider fields and requested size fields for the original providers (step 815). Ideally, the system also displays to the customer fields representing providers who did not participate in the open trades. However, the requested size fields for these new providers are typically left unpopulated. Next, at step 820, the system sends the requests for quotes corresponding to the original providers to those providers. At step 825, the system receives quotes from the original set of providers and displays these quotes to the customer with the best quotes visibly distinguished from the other quotes.

At this point, the customer may: select for execution the new quotes received from the original providers (step 830); change the requested sizes for the original providers (step 835), thereby changing the allocation of flnds among those providers; or populate the requested size fields for the new providers who did not participate in the original trades (also illustrated at step 835). If the customer selects the original providers, then the system transmits offers to deal to the original providers to roll the open trades (step 840), receives confirmations on the offers to deal and fills the order (step 860). On the other hand, if the customer changes the requested size fields for the original providers or populates the requested size fields for new providers, then the system will produce and send new requests for quotes to all providers with populated requested size fields (step 845). The system then receives and displays to the customer new quotes received from the original and the new providers (step 850). At step 855, the customer may use the input device to select a set of providers for the rollover, which may include only the original providers, only the new providers, or a combination of new providers and original providers. The system will then send offers to deal to the selected original and new providers (step 865), receive confirmations on the offers to deal, and fill the order (step 860).

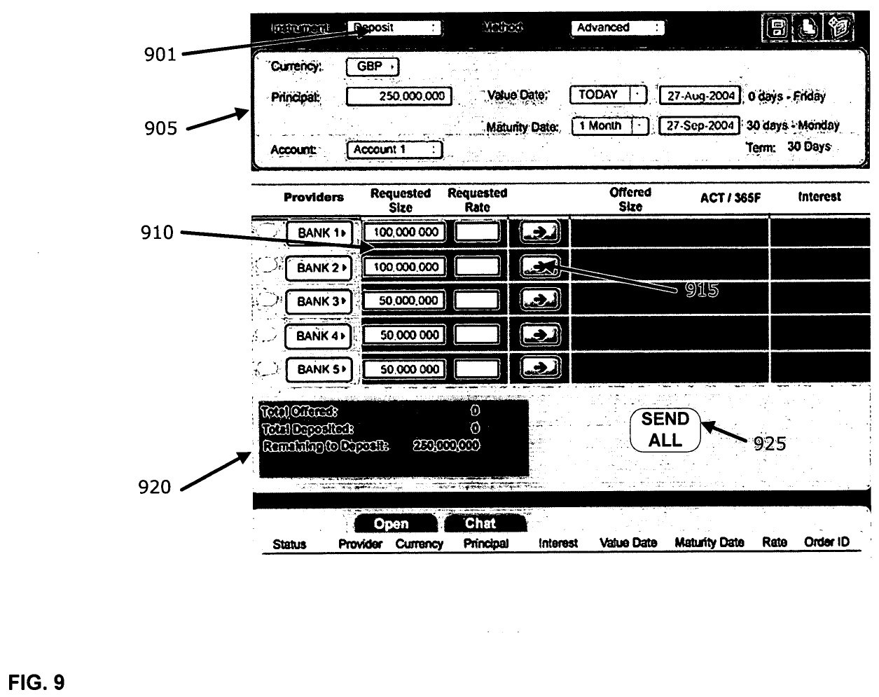

FIGS. 9, 10, 11 and 12 contain exemplary screenshots of user interface screens that could be used to execute money market instrument trades according to embodiments of the present invention. These screens are typically drawn on the display device under the operation and control of the user interface controller. As shown in FIG. 9, a preferred user interface screen includes an electronic trading ticket having an instrument control field 901 where the customer can enter the type of money market instrument to be traded, such as a loan, deposit, certificate of deposit, etc. The ticket also includes a trade detail section 905 where the user can supply trade details such as the currency, principal size, trading account, value date and maturity date for the trade. When the customer has entered the trade details, the user interface controller automatically generates and displays a first collection of fields 910, comprising providers, requested sizes and requested rates, together representing a plurality of requests for quotes that will be sent to the specified providers upon activation of the start control 925 (shown in FIG. 9 as the “SEND ALL” button). The customer may also manipulate the input device to select one of the “submit single RFQ” buttons 915, which will cause the user interface controller to submit an individual request for quote to the individual provider on the row containing the selected button.

In the example shown in FIG. 9, the providers who will receive the plurality of requests for quotes are BANK 1, BANK 2, BANK 3, BANK 4 and BANK 5. In preferred embodiments, the list of providers who will receive the requests may be modified by the customer by selecting the button containing the provider's name. Selection of this button will display a “drop-down” box containing the names of other providers with whom the customer has sufficient authority and credit to execute a trade. The requested size for each provider may be defaulted to the principal size entered in the detail section 905 ($250 million in this case), but it can be modified by the customer before activating the start control 925 to send the quotes to the providers. In the example shown in FIG. 9, for instance, the customer has modified the requested sizes so that BANK 1 and BANK 2 will each receive requests for quotes having sizes of $100 million, while BANK 3, BANK 4 and BANK 5 will each receive requests for quotes having sizes of $50 million. The user interface screen also includes a “Remaining To Deposit” counter 920, which shows how much of the principal size remains to be loaned or deposited ($250 million in this case because no RFQs have been submitted yet and no amount has been deposited).

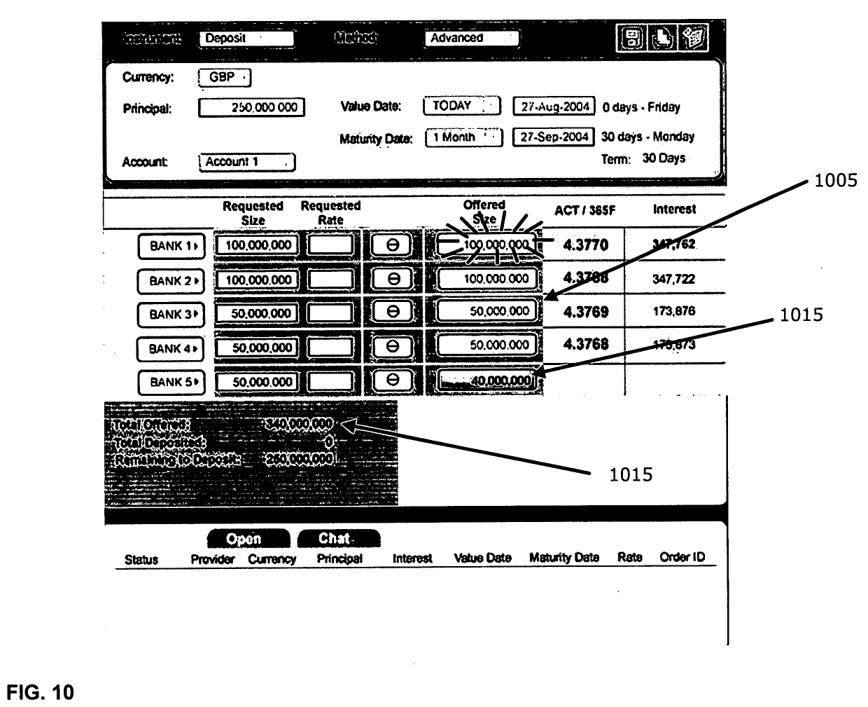

FIG. 10 shows an exemplary user interface screen of the present invention after the customer has activated the start control 925 “SEND ALL” button illustrated in FIG. 9 and the system has received a plurality of quotes from the plurality of providers BANK 1, BANK2, BANK 3, BANK 4 and BANK 5. As shown in FIG. 10, the user interface controller displays a second collection of fields 1005 on the trading ticket, comprising offered sizes, rates and interest, together representing a plurality of quotes received from the providers. In this example, BANK 1, BANK 2, BANK 3 and BANK 4 have all submitted quotes having offered sizes equal to the requested sizes in the requests for quotes, while BANK 5 has submitted a quote 1010 having an offered size that is less than the requested size. In preferred embodiments of the invention, the quote processor will identify BANK 1's quote as the best quote, since it comprises the deposit instrument quote having the numerically highest rate, and BANK 5's quote as insufficient, since it comprises a quote having an offered size that is less than the requested size. As such, preferred embodiments of the user interface controller would visibly distinguish the fields (or buttons) representing those quotes. Accordingly, the offered size button for BANK 1 is shown to be blinking in FIG. 10, while the offered size button for BANK 5 contains bold and/or specially-colored text. As shown in FIG. 10, the user interface screen also contains a “total offered” counter 1015, which indicates to the customer the total offered size for all of the received quotes.

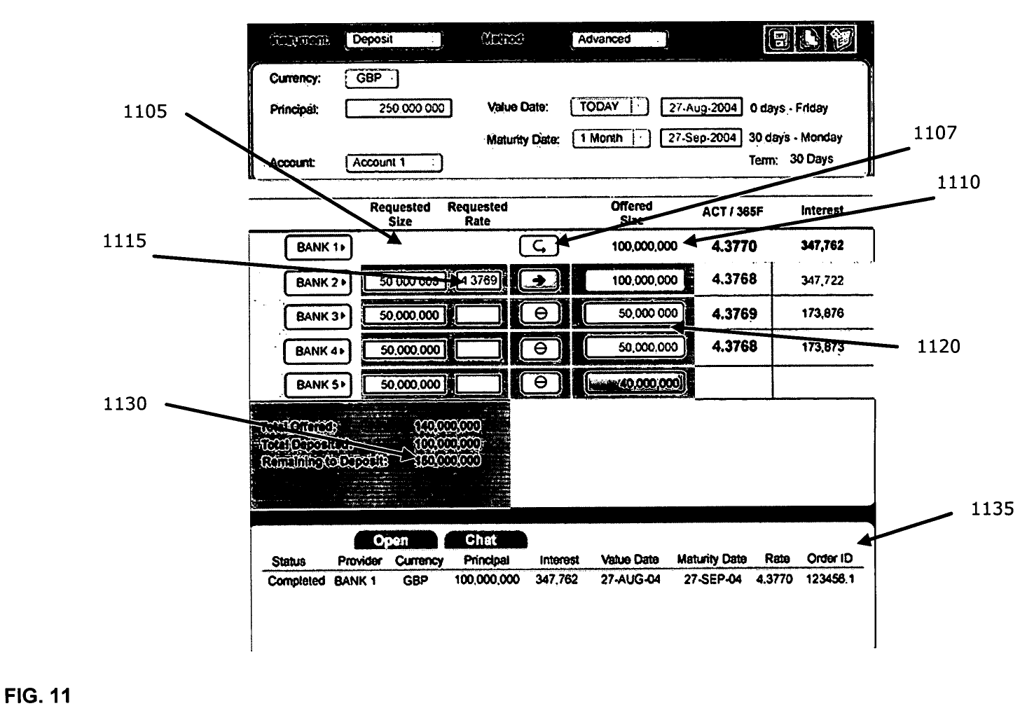

FIG. 11 shows an exemplary user interface screen of the present invention after the customer has manipulated the input device to select one of the quotes. In the example shown in FIG. 11, a deposit of $100 million has already been executed with BANK 1, which is why the requested size and requested rate fields 1105 next to BANK 1 are blank and the offered size field 1110 can no longer be activated. In addition, the amount deposited with BANK 1 has been subtracted from the Remaining to Deposit Counter 1130, which now has a value of $150 million. Moreover, preferred embodiments of the invention provide a completed trade blotter 1135, displayed at the bottom of the display device, which shows the details of the completed trade with BANK 1. If the customer wishes to negotiate a second deposit with BANK 1, he may reset the BANK 1 fields by activating the reset button 1107. Meanwhile, the original quotes received from BANK 3, BANK 4 and BANK 5 are still available for execution. As shown in FIG. 11, the customer can also negotiate a price with BANK 2 by terminating the request for quote for BANK 2, changing the requested rate field 1115 beside BANK 2's name, and submitting a new request for quotes.

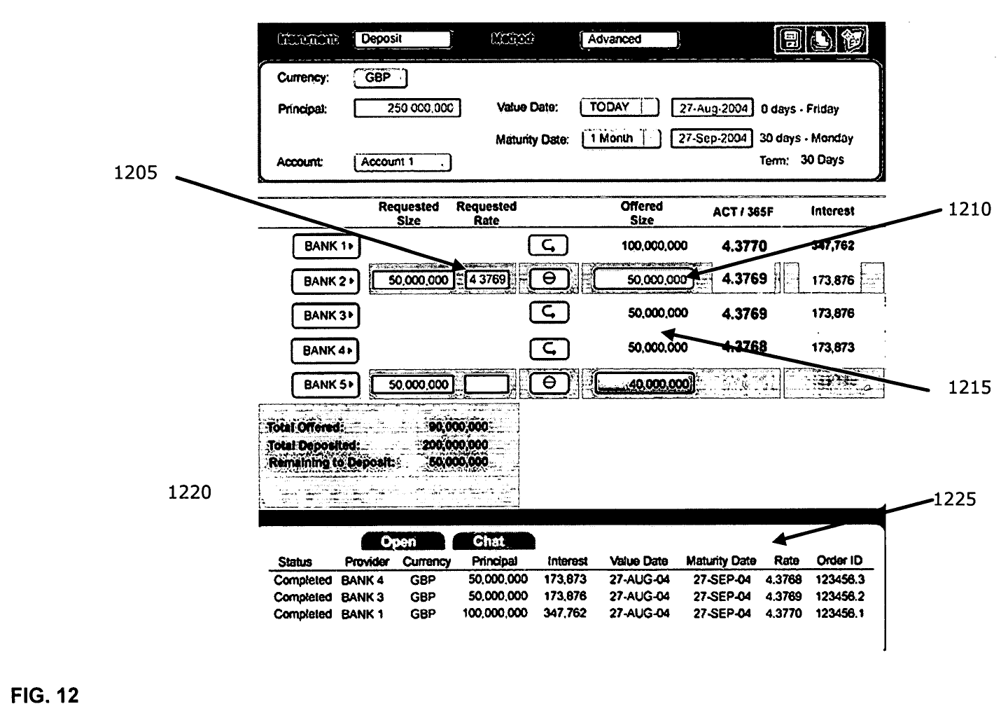

In the exemplary screenshot of FIG. 12 the customer has sent to BANK 2 a new request for quotes, wherein the requested rate 1205 is set to the value “4.3769.” BANK 2 has responded to the new request for quotes by submitting a new quote 1210 matching the requested rate. In addition, the original offers from BANK 3 and BANK 4 (see 1215) have now been executed. Therefore, the completed trades blotter 1225 shows the completed trades for BANK 1, BANK 3 and BANK 4 for $100 million, $50 million and $50 million, respectively, for a total of $200 million deposited, and the “Remaining To Deposit” counter 1220 has been appropriately decremented to just $50 million.

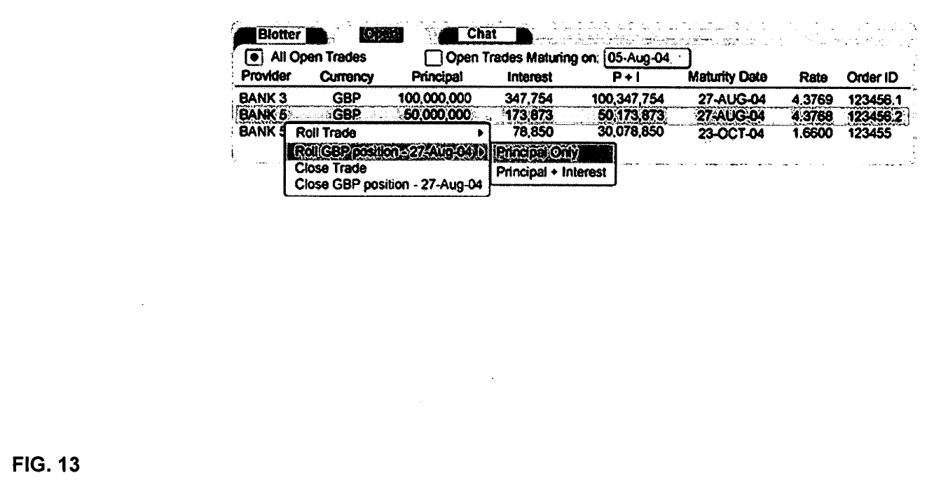

FIGS. 13, 14 and 15 contain exemplary screenshots of user interface screens that could be used to roll positions according to embodiments of the present invention. FIG. 13 shows an optional “open trade” log, which displays to the customer all open trades, or all trades maturing on a specified date. In preferred embodiments, and as shown in FIG. 13, the customer can access a menu to roll trades by, for example, by using his mouse to select an open trade and then bring up a roll position menu by “right-clicking” on the selected trade. As shown on the menu, customers may roll single trades or roll their entire currency position with respect to a particular maturity date. Customers also may choose to roll either the principal only, or the principal and interest for the maturing trade. In FIG. 13, for instance, the customer has elected to roll his entire GBP position (principal only) for trades having a maturity date of Aug. 27, 2004. There are two GBP trades maturing on this date, totaling $150 million, which are on deposit with BANK 3 and BANK 5. Since only the principal will be rolled, the interest on the component deposits will be settled.

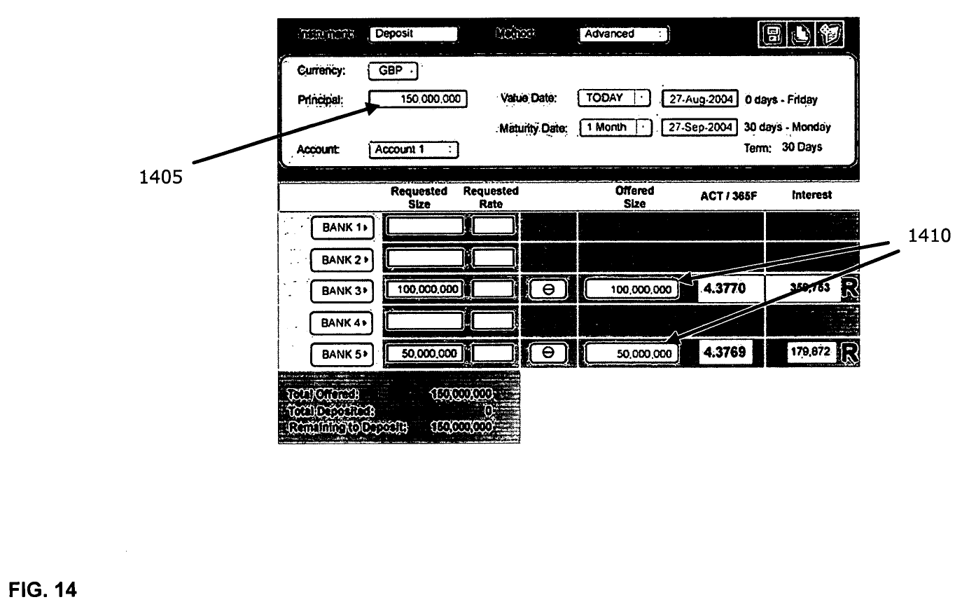

FIG. 14 illustrates what happens when the customer makes the selections in the open trade log panel as illustrated by FIG. 13. The user interface controller produces a new trading ticket similar to the trading ticket described above with reference to FIGS. 9, 10, 11 and 12. In this case, however, the principal field 1405 is pre-populated with the total GBP ($150 million) position for the selected value date (Aug. 27, 2004). The requested size fields for the original providers (BANK 3 and BANK 5) are pre-populated with requested sizes equal to the amounts those providers currently have on deposit for the open trade (i.e., $100 million and $50 million, respectively), while the requested size fields for the other providers (BANK 2, BANK 3 and BANK 4) are left blank. In addition, the user interface controller has automatically sent requests for quotes to the original providers and received rates from the original providers indicating the sizes and rates those banks will offer for rolling over the open trades for another term. The customer may click on the offered size buttons 1410 to select BANK 3 and BANK 5, and both trades will be rolled over for the additional term.

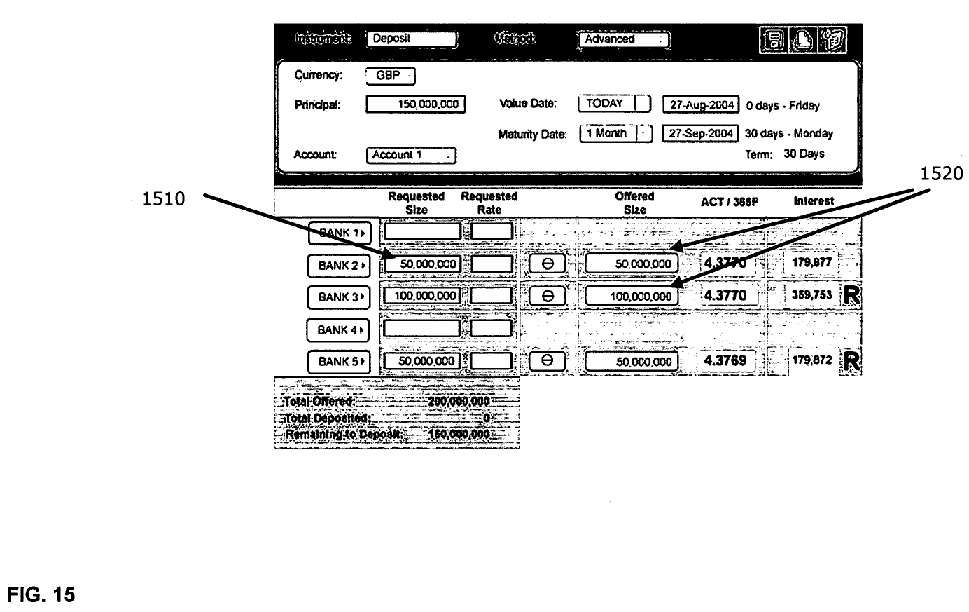

Alternatively, and as shown in FIG. 15, the customer may populate the requested size field 1510 for BANK 2 and submit a new request for quotes to BANK 2 in order to see the size and rate BANK 2 would offer for the rollover deposit. When BANK 2 responds by submitting a quote, the user interface controller displays details for BANK 2's quote in the row 1520 beside BANK 2's name. If the customer now executes with BANK 2 and BANK 3, the full GBP position for this maturity date will be effectively rolled to a new maturity date. In particular, the original deposit (principal and interest) with BANK 5 will be closed and settled, the deposit with BANK 3 (minus the interest) will be rolled, and a new deposit (the principal from the original deposit with BANK 5) will be placed at BANK 2.

The present invention has been disclosed and described herein in what is considered to be its most preferred embodiments. It should be noted that variations and equivalents may occur to those skilled in the art upon reading the present disclosure and that such variations and equivalents are intended to come within the scope of the invention and the appended claims.

What is claimed is:

1. A computer system for trading money market instruments, comprising:
a network interface for communication with a plurality of providers;
a display device;
an input device which can be manipulated by a human operator to supply a principal size for a money market transaction and to activate a start control displayed on said display device; and
a user interface controller that will:
i) produce a plurality of requests for quotes for said plurality of providers, each request for quote having a requested size, wherein at least one request for quote has a requested size that is less than said principal size;
ii) cause said display device to display a first collection of fields representing said plurality of requests for quotes, and
iii) responsive to manipulation of said input device by the operator to activate said start control, send said plurality of requests for quotes to said plurality of providers via said network interface substantially simultaneously.

2. The computer system of claim 1, wherein every requested size in said plurality of requests for quotes is less than said principal size.

3. The computer system of claim 2, wherein the sum of said every requested size in said plurality of requests for quotes is equal to said principal size.

4. The computer system of claim 1, wherein:
said first collection of fields includes a requested size field representing said requested size; and
said user interface controller will change said requested size responsive to manipulation of said input device by said human operator to supply a value for said requested size field.

5. The computer system of claim 1, wherein:
said first collection of fields includes a requested rate field representing a requested rate for said at least one request for quote; and
said user interface controller will change said requested rate responsive to manipulation of said input device by said human operator to supply a value for said requested rate field.

6. The computer system of claim 1, wherein:
said first collection of fields includes a plurality of provider fields representing respectively said plurality of providers; and
said user interface controller will change a provider in said plurality of providers responsive to manipulation of said input device by said human operator to change a provider field in said plurality of provider fields.

7. The computer system of claim 1, wherein said user interface controller:
receives via said network interface a plurality of quotes from said plurality of providers;
displays on said display device a second collection of fields representing said plurality of quotes; and
in response to manipulation of said input device by said human operator to select a first quote represented by said second collection of fields, said first quote being associated with a first provider, sends a first offer to deal to said first provider via said network interface.

8. The computer system of claim 7, further comprising an order processor that:
receives from said first provider, via said network interface, a confirmation for said first offer to deal; and
processes a first order for said money market transaction using said first quote and said first provider.

9. The computer system of claim 8, wherein manipulation of said input device by said human operator to select said first quote does not operate to prevent said human operator from subsequently manipulating said input device to select a second quote.

10. The computer system of claim 8, wherein:
in response to manipulation of said input device by said human operator to select a second quote represented by said second collection of fields, said second quote being associated with a second provider, said user interface controller sends a second offer to deal to said second provider via said network interface.

11. The computer system of claim 10, wherein said order processor:
receives from said second provider, via said network interface, a confirmation for said second offer to deal; and
processes a second order for said money market transaction using said second quote and said second provider.

12. The computer system of claim 11, wherein manipulation of said input device by said human operator to select said second quote does not operate to prevent said human operator from subsequently manipulating said input device to select a third quote.

13. The computer system of claim 11, wherein:
in response to manipulation of said input device by said human operator to select a third quote represented by said second collection of fields, said third quote being associated with a third provider, said user interface controller sends a third offer to deal to said third provider via said network interface.

14. The computer system of claim 13, wherein said order processor:
receives from said third provider, via said network interface, a confirmation for said third offer to deal; and
processes a third order for said money market transaction using said third quote and said third provider.

15. The computer system of claim 7, further comprising a quote processor that will identify a best quote in said plurality of quotes, said best quote having a requested rate that is greater than or equal to all other quotes in said plurality of quotes.

16. The computer system of claim 15, wherein
said user interface controller is further configured to display said best quote on said display device in a manner that is visually distinct from said all other quotes.

17. The computer system of claim 7, further comprising a quote processor that will identify a best quote in said plurality of quotes, said best quote having a requested rate that is less than or equal to all other quotes in said plurality of quotes.

18. The computer system of claim 17, wherein
said user interface controller is further configured to display said best quote on said display device in a manner that is visually distinct from said all other quotes.

19. The computer system of claim 1, further comprising a memory storage area for storing said principal size.

20. A method for trading money market instruments on a computer system, comprising:
a) providing a network interface for communication with a plurality of providers;
b) providing a display device;
c) providing an input device which can be manipulated by a human operator to supply a principal size for a money market transaction and to activate a start control displayed on said display device; and
d) providing a user interface controller that will:
i) produce a plurality of requests for quotes for said plurality of providers, each having a requested size, wherein at least one requested size in the plurality of requests for quotes is less than said principal size,
ii) cause said display device to display a first collection of fields representing said plurality of requests for quotes, and
iii) in response to manipulation of said input device by the operator to activate said start control, send said plurality of requests for quotes to said plurality of providers via said network interface substantially simultaneously.

21. The method of claim 20, wherein every requested size in said plurality of requests for quotes is less than said principal size.

22. The method of claim 21, wherein the sum of said every requested size in said plurality of requests for quotes is equal to said principal size.

23. The method of claim 20, wherein:
said first collection of fields includes a requested size field representing said requested size; and
said user interface controller will change said requested size responsive to manipulation of said input device by said human operator to supply a value for said requested size field.

24. The method of claim 20, wherein:
said first collection of fields includes a requested rate field representing a requested rate for said at least one request for quote; and
said user interface controller will change said requested rate responsive to manipulation of said input device by said human operator to supply a value for said requested rate field.

25. The method of claim 20, further comprising:
receiving via said network interface a plurality of quotes from said plurality of providers;
displaying on said display device a second collection of fields representing said plurality of quotes; and
in response to manipulation of said input device by said human operator to select a first quote represented by said second collection of fields, said first quote being associated with a first provider, sending a first offer to deal to said first provider via said network interface.

26. The method of claim 25, further comprising:
receiving from said first provider, via said network interface, a confirmation for said first offer to deal; and
processing a first order for said money market transaction using said first provider.

27. The method of claim 26, wherein manipulation of said input device by said human operator to select said first quote does not operate to prevent said human operator from subsequently manipulating said input device to select a second quote.

28. The method of claim 26, further comprising:
in response to manipulation of said input device by said human operator to select a second quote represented by said second collection of fields, said second quote being associated with a second provider, sending a second offer to deal to said second provider via said network interface.

29. The method of claim 28, further comprising:
receiving from said second provider, via said network interface, a confirmation for said second offer to deal; and
processing a second order for said money market transaction using said second provider.

30. The method of claim 29, wherein manipulation of said input device by said human operator to select said second quote does not operate to prevent said human operator from subsequently manipulating said input device to select a third quote.

31. The method of claim 29, further comprising:
in response to manipulation of said input device by said human operator to select a third quote represented by said second collection of fields, said third quote being associated with a third provider, sending a third offer to deal to said third provider via said network interface.

32. The method of claim 31, further comprising:
receiving from said third provider, via said network interface, a confirmation for said third offer to deal; and
processing a third order for said money market transaction using said third provider.

33. The method of claim 25, further comprising:
identifying a best quote in said plurality of quotes, said best quote having a requested rate that is greater than or equal to all other quotes in said plurality of quotes; and
displaying said best quote on said display device in a manner that is visually distinct from said all other quotes.

34. The method of claim 25, further comprising:
identifying a best quote in said plurality of quotes, said best quote having a requested rate that is less than or equal to all other quotes in said plurality of quotes; and
displaying said best quote on said display device in a manner that is visually distinct from said all other quotes.

35. The method of claim 20, further comprising storing said principal size in a memory storage area.

36. A computer system for trading money market instruments, comprising:
means for communicating with a plurality of providers;
a display device;
input means for receiving a principal size for a money market transaction;
means for producing a plurality of requests for quotes for said plurality of providers, each having a requested size, wherein at least one requested size in the plurality of requests for quotes is less than said principal size;
means for displaying on said display device a first collection of fields representing said plurality of requests for quotes, and
means for sending said plurality of requests for quotes to said plurality of providers substantially simultaneously via said communication means.

37. The computer system of claim 36, wherein every requested size in said plurality of requests for quotes is less than said principal size.

38. The computer system of claim 37, wherein the sum of said every requested size in said plurality of requests for quotes is equal to said principal size.

39. The computer system of claim 36, further comprising:
means for receiving, via said communication means, a plurality of quotes from said plurality of providers;
means for displaying on said display device a second collection of fields representing said plurality of quotes; and
means for selecting a first quote represented by said second collection of fields, said first quote being associated with a first provider; and
means for sending a first offer to deal to said first provider via said communication means.

40. The computer system of claim 36, further comprising:
means for receiving from said first provider, via said communication means, a confirmation for said first offer to deal; and
means for processing a first order for said money market transaction using said first quote and said first provider.

41. The computer system of claim 40, wherein:
means, responsive to selection by said selection means of a second quote represented by said second collection of fields, said second quote being associated with a second provider, for sending a second offer to deal to said second provider via said communication means.

42. The computer system of claim 41, further comprising:
means for receiving from said second provider, via said communication means, a confirmation for said second offer to deal; and
means for processing a second order for said money market transaction using said second quote and said second provider.

43. A computer system for trading money market instruments, comprising:
a network interface for communication with a plurality of providers;
a display device;
an input device which can be manipulated by a human operator to activate a rollover control displayed on said display device, said rollover control being associated with an original set of open trades having a total principal size that is distributed among an original set of providers; and
a user interface controller that will:
i) obtain from said original set of providers, via said network interface, new quotes for a new set of trades corresponding to said original set of open trades,
ii) cause said display device to display a first collection of fields representing said new quotes and a plurality of requests for quotes for said plurality of providers,
iii) modify said plurality of requests for quotes responsive to manipulation of said input device by the operator to modify said first collection of fields to redistribute said total principal size, and
iv) send said modified plurality of requests for quotes to said plurality of providers via said network interface.

44. The computer system of claim 43, wherein said user interface controller:
receives from said plurality of providers, via said network interface, a plurality of quotes responsive to said modified plurality of requests for quotes;
displays on said display device a second collection of fields representing said plurality of quotes; and
in response to manipulation of said input device by said human operator to select a first quote represented by said second collection of fields, said first quote being associated with a first provider, sends a first offer to deal to said first provider via said network interface.

45. The computer system of claim 44, further comprising an order processor that:
receives from said first provider, via said network interface, a confirmation for said first offer to deal; and
processes a first order for said new set of trades using said first quote and said first provider.

46. The computer system of claim 44, wherein manipulation of said input device by said human operator to select said first quote does not operate to prevent said human operator from subsequently manipulating said input device to select a second quote.

47. The computer system of claim 44, wherein:
in response to manipulation of said input device by said human operator to select a second quote represented by said second collection of fields, said second quote being associated with a second provider, said user interface controller sends a second offer to deal to said second provider via said network interface.

48. The computer system of claim 47, wherein said order processor:
receives from said second provider, via said network interface, a confirmation for said second offer to deal; and
processes a second order for said new set of trades using said second quote and said second provider.

49. A method for trading money market instruments on a computer system, comprising:
providing a network interface for communication with a plurality of providers;
providing a display device;
providing an input device which can be manipulated by a human operator to activate a rollover control displayed on said display device, said rollover control being associated with an original set of open trades having a total principal size that is distributed among an original set of providers; and
obtaining from said original set of providers, via said network interface, new quotes for a new set of trades corresponding to said original set of open trades,
causing said display device to display a first collection of fields representing said new quotes and a plurality of requests for quotes for said plurality of providers,
modifying said plurality of requests for quotes responsive to manipulation of said input device by the operator to modify said first collection of fields to redistribute said total principal size, and
sending said modified plurality of requests for quotes to said plurality of providers via said network interface.

50. The method of claim 49, further comprising:
receiving from said plurality of providers, via said network interface, a plurality of quotes responsive to said modified plurality of requests for quotes;
displaying on said display device a second collection of fields representing said plurality of quotes; and
in response to manipulation of said input device by said human operator to select a first quote represented by said second collection of fields, said first quote being associated with a first provider, sending a first offer to deal to said first provider via said network interface.

51. The method of claim 50, further comprising:
receiving from said first provider, via said network interface, a confirmation for said first offer to deal; and
processing a first order for said new set of trades using said first quote and said first provider.

52. The method of claim 50, further comprising:
in response to manipulation of said input device by said human operator to select a second quote represented by said second collection of fields, said second quote being associated with a second provider, sending a second offer to deal to said second provider via said network interface.

53. The method of claim 52, further comprising:
receiving from said second provider, via said network interface, a confirmation for said second offer to deal; and
processing a second order for said new set of trades using said second quote and said second provider.
